(19) United States
(12) Patent Application Publication
(10) Pub. No.: US 2004/0109301 A1
(43) Pub. Date: Jun. 10, 2004

(54) Cooling device for an integrated circuit

(76) Inventor: Chen Shih-Tsung, Taipei (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/636,480

(22) Filed: Aug. 7, 2003

(30) Foreign Application Priority Data
Oct. 28, 2002 (TW) 091217240

(51) Int. Cl. F28F 7/00; H02B 1/01

(52) U.S. Cl. 361/829; 165/80.2; 165/76

(57) ABSTRACT

A cooling device is secured to an integrated circuit, such as a CPU, for being thermally coupled to the integrated circuit to dissipate heat therefrom. The cooling device is attached to a housing of a computer in which the integrated circuit sits. This attaching is performed by a set of fasteners, such as bolts. These fasteners may be heat conductive to aide in the dissipation of heat from the integrated circuit.

### CROSS REFERENCE TO RELATED APPLICATIONS

This application claims the right of priority based on Taiwan application serial no. 091217240, filed on Oct. 28, 2002, which is herein incorporated in its entirety by reference.

### BACKGROUND

1. Field of the Invention

The invention relates generally to cooling devices for integrated circuits, and in particular to securing a cooling device in thermal contact with an integrated circuit, such as a CPU.

2. Background of the Invention

The central processing unit (CPU) is a core component of any computer. During operation of a computer, the circuitry in the CPU can generate a relatively large amount of heat. The heat generated by the CPU tends to increase with greater capacity and faster CPUs. Like other circuitry, the CPU operates with less efficiency at higher temperatures. Accordingly, the dissipation of heat from the CPU is an important consideration in the design of a computer. Moreover, this becomes especially important as technology increases the performance, and thus the heat generation, of the CPU.

In a conventional computer assembly, heat dissipation from a CPU is performed by a cooling device attached to the top of the CPU. In some embodiments, the cooling device is a heat sink that includes a plurality of cooling fins on the top and/or sides of the heat sink. Heat generated by the CPU is guided via conduction from the top surface of the CPU to the bottom of the heat sink and then to the cooling fins of the heat sink. The heat is then drawn away from the cooling device by a cooling fan that passes a flow of air over the cooling fins. In other embodiments, the cooling device includes a heat sink coupled to a radiator by one or more heat pipes. In such a system, heat generated by the CPU is drawn from the CPU to the heat sink, through the heat pipes, and to the radiator, where it is dissipated by a cooling fan. Regardless of specific implementation of the cooling device, however, efficient heat dissipation from the CPU is promoted by good thermal contact between the CPU and the cooling device, which depends on how well the cooling device is secured to the CPU.

Typical cooling devices are attached to the top of a CPU using some form of retaining apparatus. An example retaining apparatus fits over the cooling device and CPU and engages with a CPU frame, thereby securing the cooling device over the CPU. One drawback of such a retaining apparatus is that it may not maintain good thermal contact between the cooling device and the CPU during operation of the computer. Maintaining good thermal contact between the cooling device and the CPU is important for effective heat conduction, as gaps impede the transfer of heat therebetween. Moreover, for cooling devices that have a lateral side attached to an auxiliary cooling device (e.g., by one or more heat pipes), the center of gravity of the cooling device is not aligned over the center of the CPU. This may cause the cooling device to lift off from horizontal contact with the CPU unless the cooling device is secured tightly to the CPU.

### SUMMARY OF THE INVENTION

The invention provides for securing a cooling device to an integrated circuit, such as a CPU, while maintaining good thermal coupling therebetween. The cooling device is attached to a housing of a computer in which the integrated circuit sits, and in this way, the cooling device is secured over the integrated circuit. Typically, the integrated circuit is mounted to a circuit board or is installed into a socket that is mounted to a circuit board. The circuit board, such as a motherboard of a computer, is mounted within a computer housing.

In one embodiment of the invention, an assembly includes a cooling device for being thermally coupled to an integrated circuit to dissipate heat therefrom. For example, the cooling device is placed over the integrated circuit and contacted with a top surface thereof. Fasteners are configured to operably couple with the cooling device to apply a securing force to the cooling device. In one embodiment, the fasteners are passed through corresponding holes in a base element of the cooling device, and further through corresponding holes in the circuit board. The fasteners are then received by and attached to the computer housing, for example by way of corresponding threaded mounts. When assembled, the cooling device is secured firmly to the integrated circuit so that the cooling device can dissipate heat generated by the integrated circuit.

In another embodiment, the assembly further includes a spring to be operably disposed between each fastener and the cooling device. In this way, the springs apply at least a portion of the securing force to the cooling device when assembled, serving to buffer the force applied to the cooling device.

In another embodiment, the cooling device includes a base element made of a heat conductive material. This base element includes a number of base holes and a corresponding number of base bolts that pass through the base holes. The bolts then fasten to corresponding threaded mounts in a housing of a computer, thereby securing the cooling device to the top of the CPU.

In one embodiment, the fasteners (e.g., bolts) and the computer housing are made of a heat conductive material, such as a metal. In this way, some amount of the heat generated by the integrated circuit (e.g., CPU) is removed from the computer by passing through the fasteners to the computer housing, where the heat is then dissipated into the environment.

### BRIEF DESCRIPTION OF THE DRAWINGS

FIG. 1 is a perspective partially disassembled view of a CPU cooling device in accordance with an embodiment of the invention.

FIG. 2 is a partially cut-away side view of the CPU cooling device shown in FIG. 1.

### DETAILED DESCRIPTION OF THE PREFERRED EMBODIMENTS

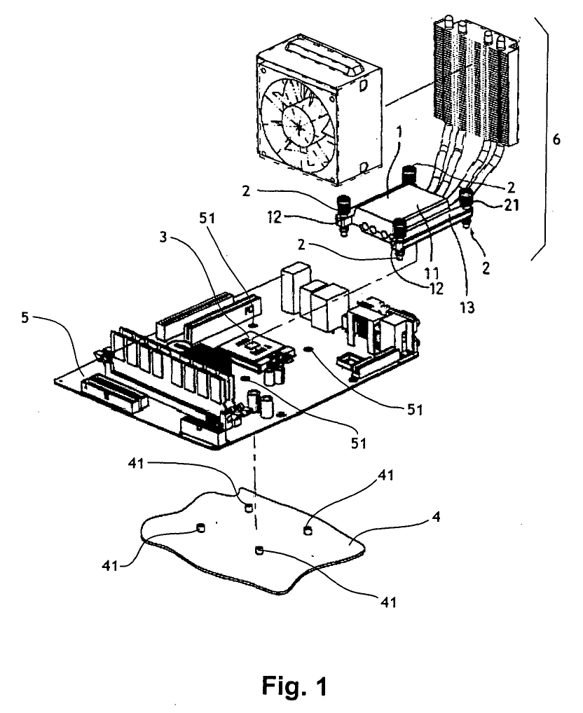

FIG. 1 shows a cooling device 6 in accordance with an embodiment of the invention. The cooling device 6 is adapted to secure to an integrated circuit 3, such as a CPU, while maintaining good thermal coupling therebetween. Typically, the integrated circuit 3 is mounted to a circuit board 5 or is installed into a socket that is mounted to a circuit board 5. The circuit board 5, such as a computer motherboard, sits inside a housing 4, such as the chassis of a computer.

The cooling device 6 includes a base element 1 and a number of base bolts 2. The cooling device 6 shown in FIG. 1 is in the form of a heat sink coupled to a radiator by a number of heat pipes; however, the cooling device 6 may be another type of device—for example, a heat sink having a number of fins from which heat is dissipated by a fan mounted on top of the heat sink. The base element 1 is a generally flat body preferably constructed of a heat conductive material, such as a metal. A bottom side of the base element 1 is provided with a flat surface for ensuring good thermal contact with the top of an integrated circuit 3. In one embodiment, the base element 1 further includes a support plane 11 for being associated with a heat dissipation device, such as a cooling fan. The support plane 11 has an elevation higher than the remaining portion of the base element 1. The base element 1 may be generally rectangular (including square).

A base hole 12 is formed at each corner of the base element 1 on an edge part 13 extending outward from two opposite sides of the support plane 11. However, the base holes 12 can alternatively be disposed anywhere along the perimeter of the base element 1, in a middle section of the base element 1, or any combination thereof. In addition, more or less than four base holes 12 can be formed. Preferably, the base holes 12 are disposed evenly and symmetrically to promote an even force applied onto the integrated circuit 3 by the cooling device 6. Further, each base hole 12 may include screw threads on an inner wall thereof.

A number of base bolts 2 are used to secure the base element 1—and thus the cooling device 6—to a computer housing 4. The base bolts 2 are passed through the base holes 12 of the base element 1. To buffer the downward urging force of the base bolts 2 onto the base element 1, each base bolt 2 is passed through a bolt spring 21 and then through the base holes 12 so that the bolt springs 21 are disposed between a head of each base bolt 2 and corresponding base hole 12. Additionally, a spring ring or a spring washer can be used in conjunction with each base bolt 2. In one embodiment, the base bolts 2 are screw bolts and are made of a heat conductive material, such as a metal. This allows heat to additionally dissipate through the base bolts 2 and to the computer housing 4. Moreover, as an alternative to bolts, other types of fasteners may be used, such as clips, screws, and any other fastener suitable for attaching the cooling device 6 to the computer housing 4.

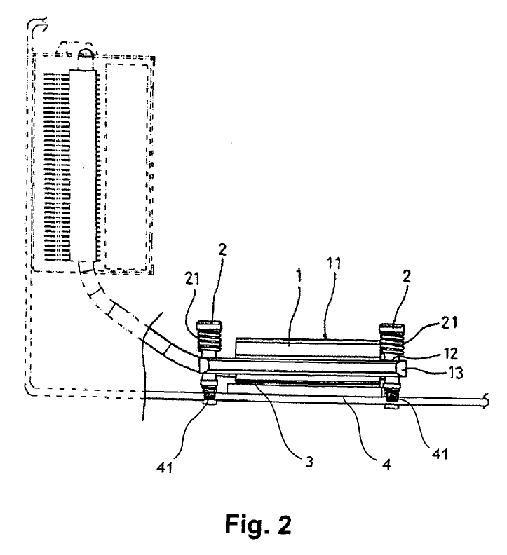

With reference to FIG. 2, the cooling device 6 is installed by placing the base element 1 on top of the integrated circuit 3. The base bolts 2 pass through bolt springs 21 and the base holes 12 to fasten to corresponding holes 41 in the computer housing 4. The holes 41 in the housing 4 may be tapped to receive the base bolts 2, or the bolts 2 may be fastened to the housing 4 using nuts outside the housing 4. Persons skilled in the art will understand that a variety of mechanisms for fastening the base element 1 to the housing 4 may be used within the scope of the present invention. Typically, the base bolts 2 also pass through one or more openings 51 in the circuit board 5 to reach the holes 41 in the housing 4. In an alternative embodiment, the base bolts 2 fasten to corresponding holes in the circuit board 5, rather than to the housing 4.

The bolt springs 21 serve to buffer the urging force applied to the base element 1 so that the base bolts 2 need not be tightened the same amount to achieve a substantially consistent force among the base bolts 2. Accordingly, the base bolts 2, by way of the bolt springs 21, apply an even securing force to the base element 1 of the cooling device 6. In this way, the base element 1 is pressed evenly and tightly against the integrated circuit 3 to make thermal contact therewith.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. For example, the base element 1 can be associated with different types of cooling devices. In other embodiments, the cooling device 6 can include a cooling fan and/or heat guide plates disposed on and joined to the base element 1. Moreover, the base element 1 need not make direct physical contact with the integrated circuit 3, as it is only important that the integrated circuit 3 and cooling device 6 be thermally coupled to allow heat to dissipate from the integrated circuit 3. It is therefore intended that the scope of the invention be limited not by this detailed description, but rather by the claims appended hereto.

I claim:

1. A computer assembly comprising:
a cooling device for being thermally coupled to an integrated circuit to dissipate heat therefrom;
a set of fasteners configured to operably couple with the cooling device and apply a securing force to the cooling device for thermally coupling the cooling device to the integrated circuit; and
a computer housing adapted to receive the fasteners.

2. The computer assembly of claim 1, wherein each fastener includes a bolt.

3. The computer assembly of claim 2, wherein each fastener further includes a spring to operably couple each bolt to the cooling device, the springs applying at least a portion of the securing force to the cooling device.

4. The computer assembly of claim 1, wherein the fasteners and the computer housing are made of a heat conductive material.

5. The computer assembly of claim 1, wherein the cooling device has a generally rectangular base element, the base element configured to receive the fasteners at about each corner thereof.

6. The computer assembly of claim 1, wherein the integrated circuit is a CPU.

7. The computer assembly of claim 1, further comprising:
a circuit board to which the integrated circuit is coupled, the circuit board having one or more openings corresponding to the fasteners to allow the fasteners to pass therethrough.

8. The computer assembly of claim 7, wherein the integrated circuit is received by a socket mounted to the circuit board.

9. A cooling device for an integrated circuit, the cooing device comprising:
a base element made of a heat conductive material, the base element including a number of base holes; and
a set of base bolts, each base bolt adapted to pass through the base element base and a corresponding base hole, each base bolt further adapted to fasten directly to a computer housing.

10. The cooling device of claim 9, wherein the base element has four corners, and a base holes is disposed at each corner thereof.

11. The CPU cooling device of claim 9, further comprising:
a bolt spring for each base bolt, each bolt spring disposed between its corresponding base bolt and base hole.

12. The CPU cooling device of claim 9, wherein the base bolts are made of a heat conductive material.

13. The CPU cooling device of claim 9, wherein a center portion of the base element has a support plane with an elevation higher than a remaining portion of the base element.

14. The CPU cooling device of claim 9, wherein the base bolts are configured to fasten to an outer housing of a computer main unit.

15. The CPU cooling device of claim 14, wherein the base bolts and the outer housing are made of a heat conductive material.

16. A method for securing a cooling device to a CPU in a computer, the method comprising:
placing the cooling device over the CPU;
passing a number of fasteners through holes in a base element of the cooling device; and
attaching the fasteners to a housing of the computer so that the fasteners apply a securing force on the cooling device towards the CPU.

17. The method of claim 16, further comprising:
passing each fastener through a spring before a hole in the base element, so that the spring is located between the hole and an end of the fastener.

18. The method of claim 16, wherein the fasteners are bolts made of a heat conductive material.

19. The method of claim 16, wherein the CPU is mounted on a motherboard, the motherboard having a number of holes to allow the fasteners to pass therethrough, the method further comprising:
aligning the holes of the base element with the holes in the motherboard; and
passing the fasteners through the holes in the motherboard.
